(19) United States
(12) Patent Application Publication
(10) Pub. No.: US 2011/0290977 A1
(43) Pub. Date: Dec. 1, 2011

(54) LED panel holder

(76) Inventors: Ming Feng Lin, Shenzhen (CN); Wei Wang, Shenzhen (CN); Ping Lin Zhao, Shenzhen (CN); Jingang Zhang, Shenzhen (CN)

(21) Appl. No.: 12/790,967

(22) Filed: May 31, 2010

(51) Int. Cl. F21V 21/30; F21V 21/00; F16M 11/10

(52) U.S. Cl. 248/397

(57) ABSTRACT

An LED panel holder includes a rectangular case (1) comprising a longitudinal groove (1a) on a central portion of back, slots (1d) on one side, hooks (1e) on the other side, the hooks (1e) adapted to lockingly engage with the slots (1d), projecting members (1b, 1c) on top, and recessed members (1b, 1c) on bottom, the recessed members (1b, 1c) being complementary to the projecting members (1b, 1c); and a support assembly (2) comprising an elongated support (2a) releasably secured to the groove (1a), a base (2c) having one end pivotably secured to bottom of the groove (1a), and an arm (2b) having one end adjustably secured to the support (2) and the other end pivotably secured to the other end of the base (2c). The support assembly (2) is adapted to retract into the groove (1a) to render the back of the case (1) to be substantially flat.

### BACKGROUND OF THE INVENTION

1. Field of Invention

The invention relates to holding devices and more particularly to an LED panel holder with improved characteristics.

2. Description of Related Art

An LED panel is a small video display which uses light-emitting diodes (LEDs). LED panels are sometimes used as form of lighting, for the purpose of general illumination, task lighting, or even stage lighting rather than display.

LED panels are fragile. Hence, how to safely package an LED panel in a shipping container (e.g., box) is important. Typically, a holder is mounted to an LED panel prior to putting into a box. Moreover, package cushioning is added to stably hold the LED panel in the box.

However, the LED panel supported by two arms of the conventional holder is not stable since box back and bottom may be uneven. Moreover, its packaging is somewhat difficult as complained by many employees. Thus, the need for improvement still exists.

### SUMMARY OF THE INVENTION

It is therefore one object of the invention to provide an LED panel holder comprising a rectangular case having an open front and comprising a longitudinal groove on a central portion of back, a plurality of slots on one side, a plurality of hooks on the other side, the hooks being adapted to lockingly engage with the slots, a plurality of projecting members on top, and a plurality of recessed members on bottom, the recessed members being complementary to the projecting members; and a support assembly comprising a support releasably secured to the groove, a base having one end pivotably secured to bottom of the groove, and an arm having one end adjustably secured to the support and the other end pivotably secured to the other end of the base, wherein the support assembly is adapted to retract into the groove to render the back of the case to be substantially flat.

The above and other objects, features and advantages of the invention will become apparent from the following detailed description taken with the accompanying drawings.

### BRIEF DESCRIPTION OF THE DRAWINGS

FIG. 1 is a perspective view of an LED panel holder according to the invention;

FIG. 2 is a view similar to FIG. 1 with the support assembly being retracted onto the back groove and the protective cap removed;

FIG. 3 is a rear view of FIG. 2;

FIG. 4 is a top view of FIG. 1 with the protective cap removed;

FIG. 5 is a bottom view of FIG. 1;

FIG. 6 is a side view of FIG. 1 with the protective cap removed;

FIG. 7 is a side view of FIG. 1 with the case tilted;

FIG. 8 is a perspective view of the support assembly;

FIG. 9 is another perspective view of the support assembly; and

FIG. 10 is a detailed view of the area in an oval of FIG. 1.

### DETAILED DESCRIPTION OF THE INVENTION

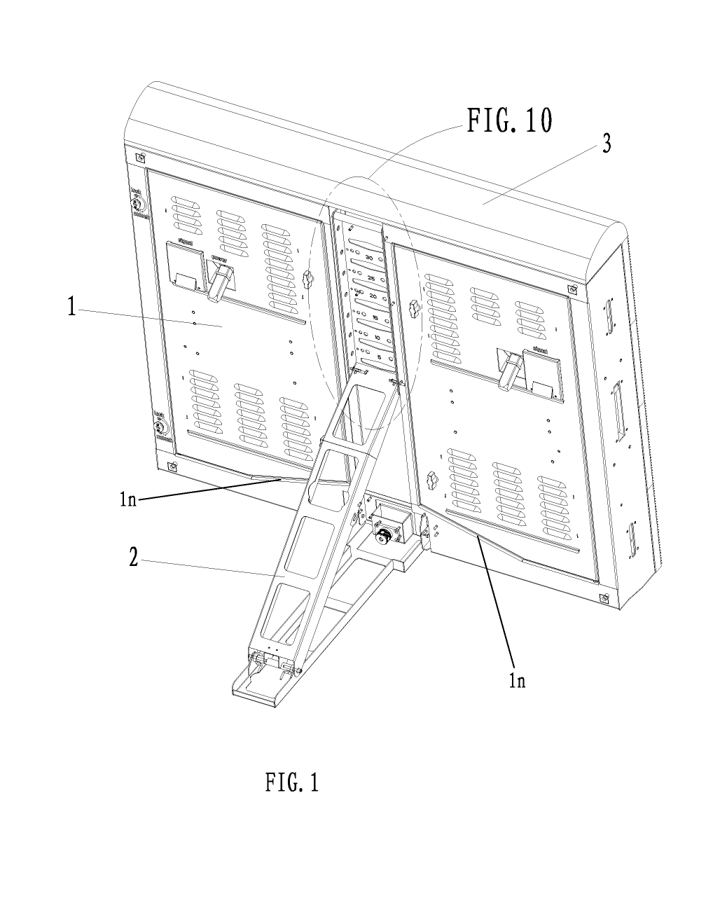

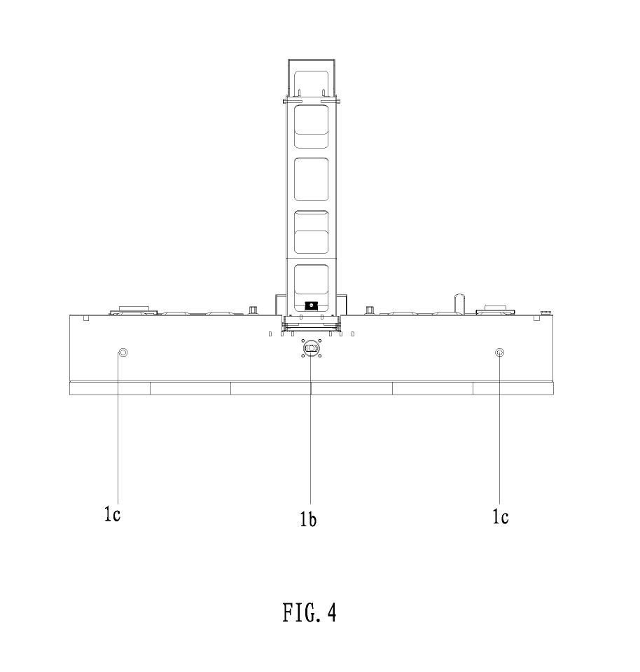

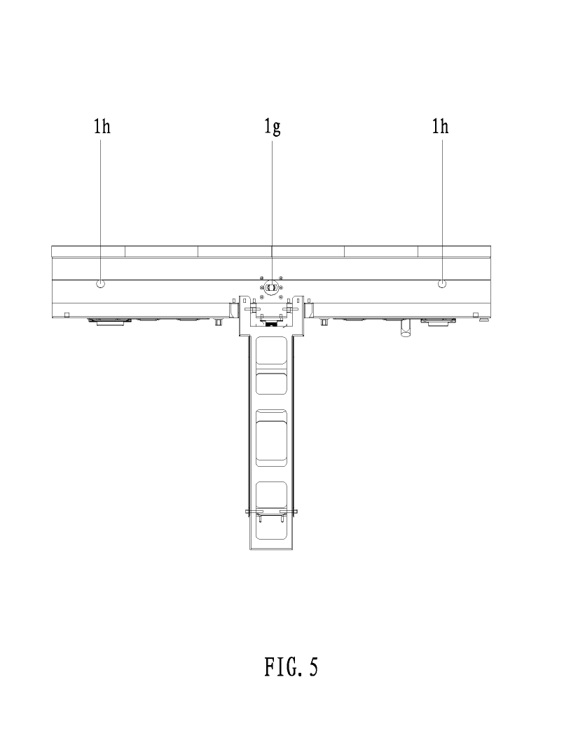

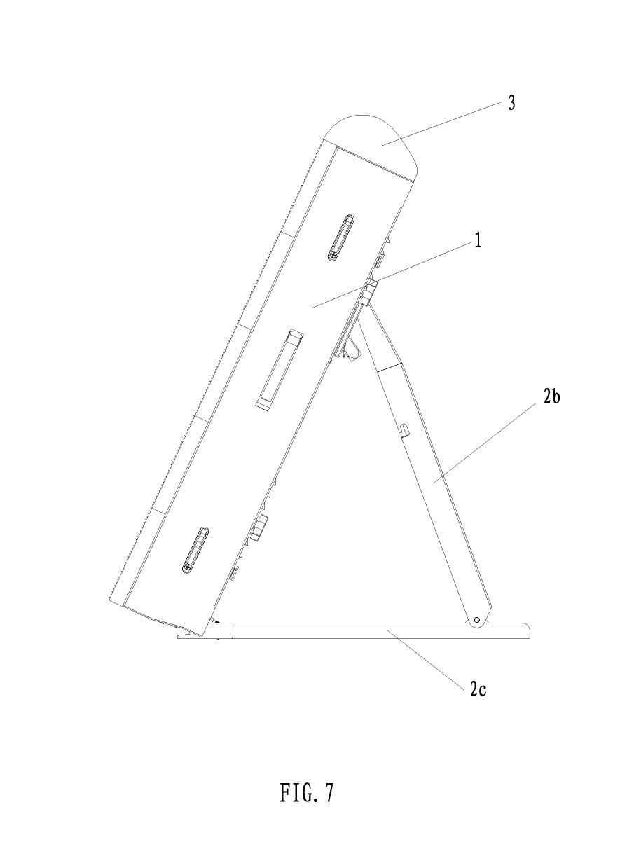

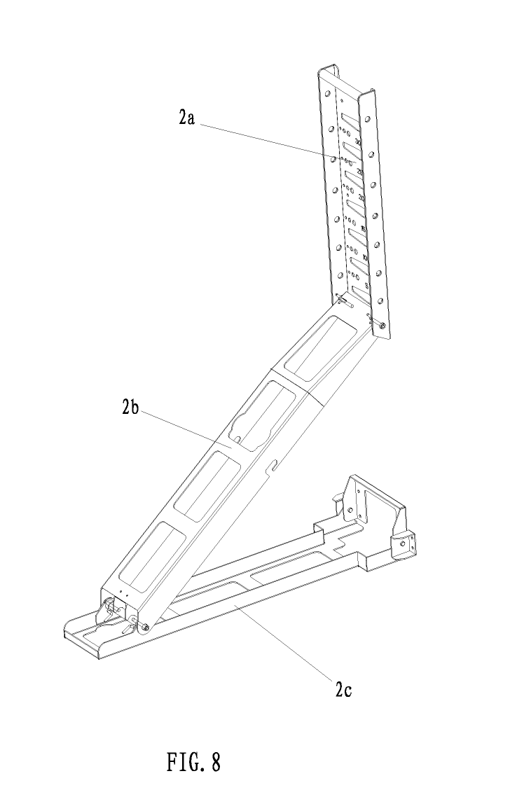

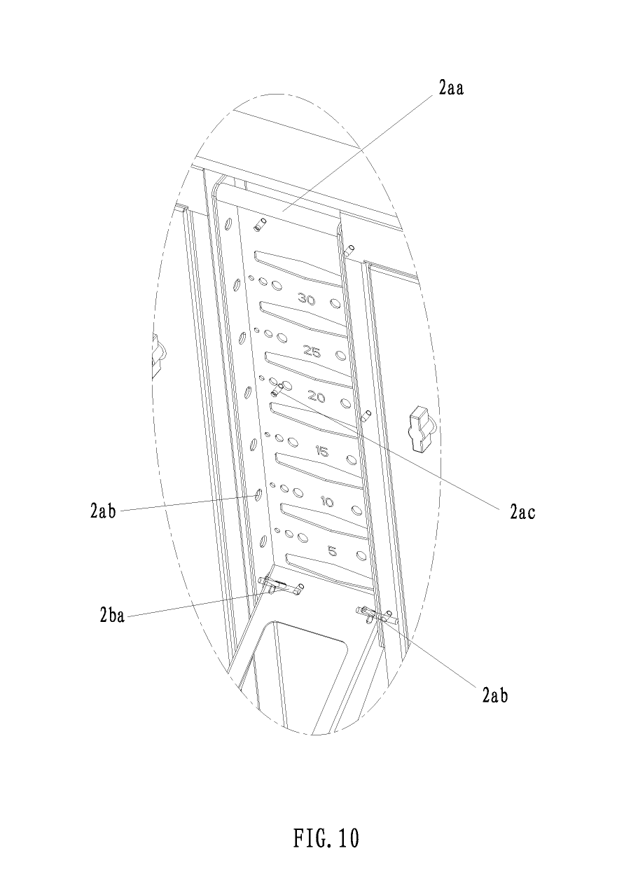

Referring to FIGS. 1 to 10, an LED panel holder in accordance with the invention comprises a case 1 having a back, an open front, and a rectangular member formed around the back, the case 1 being adapted to receive an LED panel (not shown), a support assembly 2 and a protective cap 3 each as discussed in detail below.

The support assembly 2 comprises a support 2a, an arm 2b, and a base 2c rested upon a flat surface. The support 2a is elongated and has a section of U. The support 2a has a plurality of fasteners (e.g., screws) 2ac for securing the support 2a to the case 1, and a top cross bar 2aa. The support 2a is complimentarily fastened in a longitudinal groove 1a on a central portion of the back of the case 1. The groove 1a has a cross-section of rectangle. The support 2a comprises a plurality of equally spaced apart holes 2ab along either side.

The arm 2b comprises two opposite spring depressible sliding pins 2ba at one end and has the other end pivotably secured to one end of the base 2c. The sliding pin 2ba has a handle 2bb so that aligning the sliding pins 2ba with the holes 2ab by holding the handles 2bb and releasing the handles 2bb can insert portions of the sliding pins 2ba into the holes 2ab to secure the arm 2 to the support 2a. To the contrary, pulling the handles 2bb to cause the sliding pins 2ba to clear the holes 2ab can detach the arm 2b from the support 2a. That is, a coupling point of the support 2a and the arm 2b is adjustable.

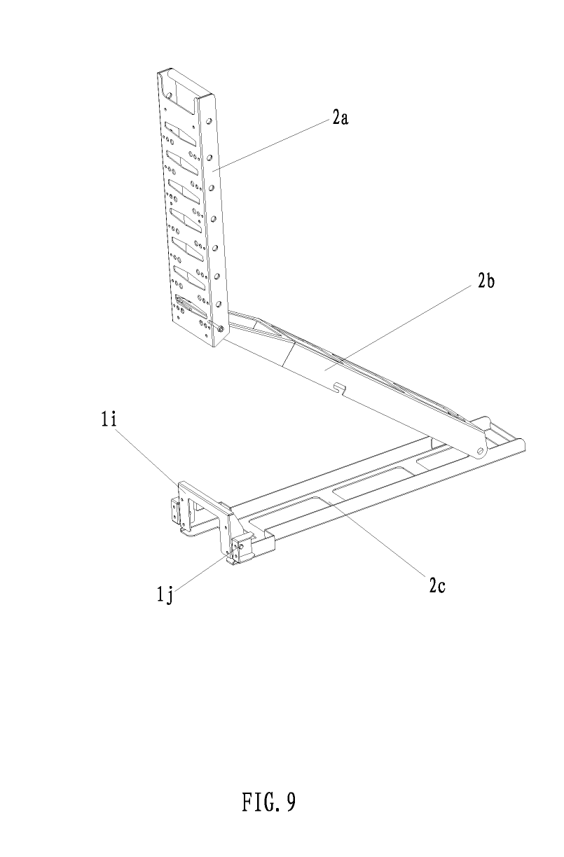

The other end of the base 2c is pivotably secured to two pivotal mounts 1j at both sides of an inverted U member 1i which is provided at the bottom end of the groove 1a respectively (see FIG. 9). Thus, the base 2c can pivot about the case 1. The base 1c has a width less than that of the arm 2b so that the base 1c can be received in the inverted U shaped arm 2b by pivoting about one end of the base 2c.

The protective cap 3 is releasably fitted on top of the case 1. One side of the case 1 is provided with a plurality of (two) spaced slots 1d and the other side thereof is provided with a plurality of (two) hooks 1e. The hooks 1e of one case 1 can be inserted into the slots 1d of another case 1 so that the two cases 1 can be coupled together transversely.

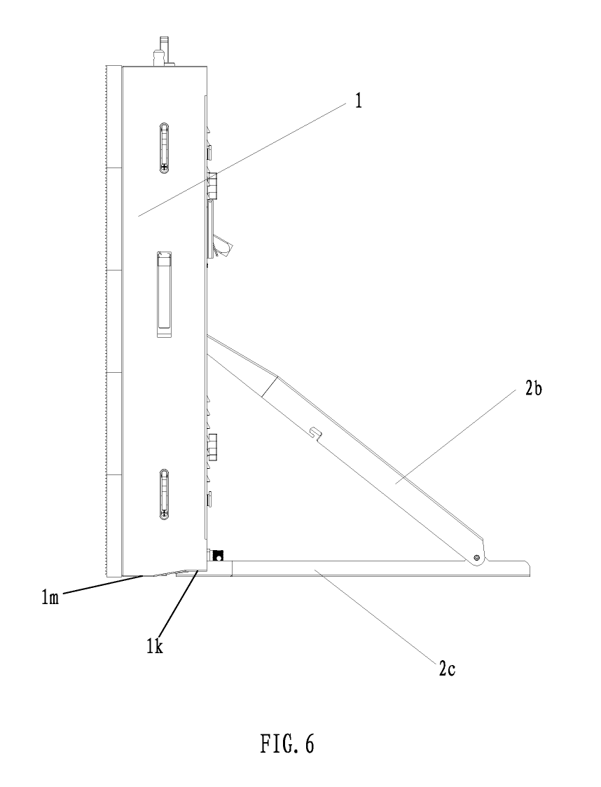

A rear half portion 1k of the bottom of the case 1 has a higher elevation that a front half portion 1m thereof. That is, the rear half portion 1k is recessed vertically as shown in FIG. 6. This has the benefit of permitting the case 1 to tilt relative to the base 2c. On back of the case 1 there are provided a positioning aperture 1f on each of four corners thereof and an inclined lower edge 1n on each of the right and left portions. On top of the case 1 there are provided with a central projection 1b adjacent top end of the groove 1a, and left and right protrusions 1c. On bottom of the case 1 there are provided a central positioning hole 1b adjacent bottom end of the groove 1a, and left and right apertures 1c. The projection 1b of one case 1 can be fitted into the positioning hole 1b of another case 1 and the protrusions 1c of one case 1 can be fitted into the apertures 1c of another case 1 so that the two cases 1 can be coupled together longitudinally (i.e., stacked).

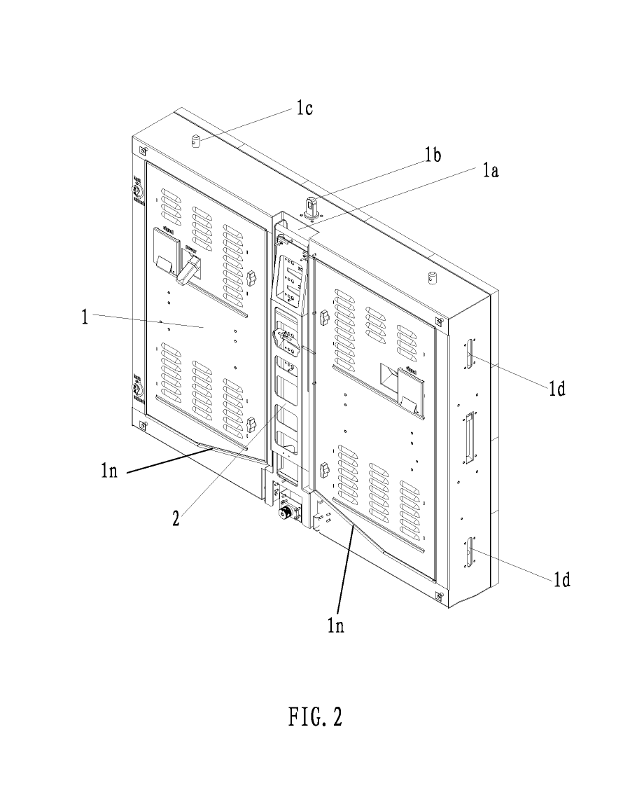

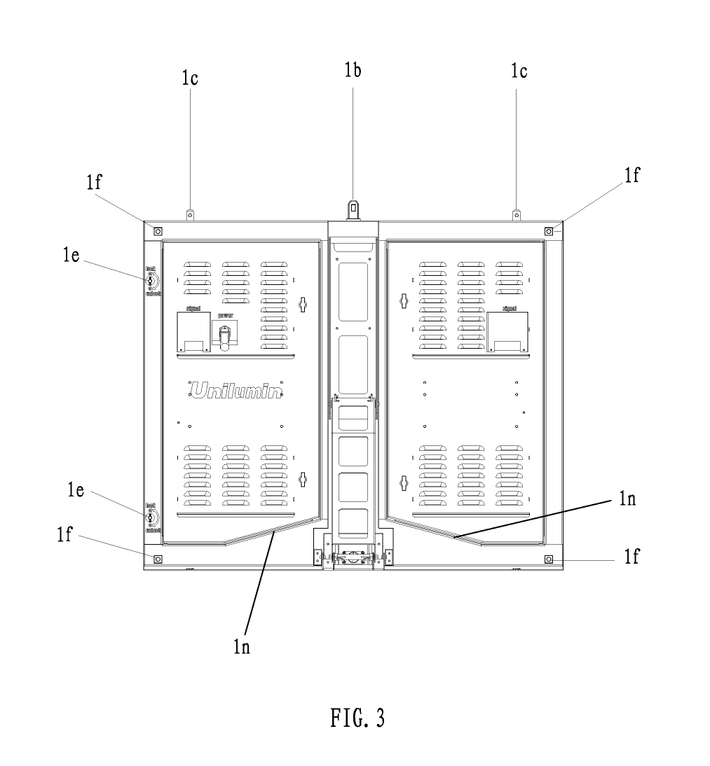

As shown in FIGS. 2 and 3, a flat back of the case 1 is rendered when the support assembly 2 is folded into the groove 1a. This ensures a stable package of the case 1 in a shipping container.

While the invention has been described in terms of preferred embodiments, those skilled in the art will recognize that the invention can be practiced with modifications within the spirit and scope of the appended claims.

What is claimed is:

1. An LED (light-emitting diode) panel holder comprising:
a rectangular case (1) having an open front and comprising a longitudinal groove (1a) on a central portion of back, a plurality of slots (1d) on one side, a plurality of hooks (1e) on the other side, the hooks (1e) being adapted to lockingly engage with the slots (1d), a plurality of projecting members (1b, 1c) on top, and a plurality of recessed members (1b, 1c) on bottom, the recessed members (1b, 1c) being complementary to the projecting members (1b, 1c); and
a support assembly (2) comprising an elongated support (2a) releasably secured to the groove (1a), a base (2c) having one end pivotably secured to bottom of the groove (1a), and an arm (2b) having one end adjustably secured to the support (2) and the other end pivotably secured to the other end of the base (2c),
wherein the support assembly (2) is adapted to retract into the groove (1a) to render the back of the case (1) to be substantially flat.

2. The LED panel holder of claim 1, further comprising a protective cap (3) complimentarily fitted on the top of the case (1).

3. The LED panel holder of claim 1, wherein the support (2a) comprises a plurality of holes (2ab) along either side.

4. The LED panel holder of claim 3, wherein the arm (2b) comprises two opposite sliding pins (2ba) at one end, the sliding pins (2ba) being adapted to partially insert into the holes (2ab) of the same elevation for locking.

5. The LED panel holder of claim 1, wherein the base (1c) has a width less than that of the arm (2b).

6. The LED panel holder of claim 1, wherein the arm (2b) is shaped as an inverted U.

7. The LED panel holder of claim 1, further comprising a positioning aperture (1f) on each of four corners of the back of the case (1).

8. The LED panel holder of claim 1, wherein a rear half portion (1k) of the bottom of the case (1) is recessed relative to a front half portion (1m) thereof.
